(19) United States
(12) Patent Application Publication
(10) Pub. No.: US 2024/0254339 A1
(43) Pub. Date: Aug. 1, 2024

(54) COATING SYSTEM FOR PROTECTING A SUBSTRATE

(71) Applicants: FONDAZIONE ISTITUTO ITALIANO DI TECNOLOGIA, Genova (IT); BEDIMENSIONAL S.P.A., Genova (IT)

(72) Inventors: Sebastiano BELLANI, Genova (IT); Luca GABATEL, Genova (IT); Esau Antonio DEL RIO CASTILLO, Genova (IT); Sanjay Balkrishna THORAT, Genova (IT); Miguel Angel MOLINA GARCIA, Genova (IT); Leyla NAJAFI, Genova (IT); Francesco BONACCORSO, Genova (IT)

(21) Appl. No.: 18/561,645

(22) PCT Filed: May 20, 2022
(86) PCT No.: PCT/IB2022/054717

§ 371 Date: Nov. 16, 2023

(30) Foreign Application Priority Data
May 20, 2021 (IT) 102021000013169

(51) Int. Cl. C09D 5/08; C08K 7/00; C09D 1/00; C09D 7/40; C09D 7/61

(52) U.S. Cl. CPC C09D 5/084; C09D 1/00; C09D 7/61; C09D 7/70; C08K 7/00

(57) ABSTRACT

The present invention relates to a coating system for protecting a substrate comprising at least one layer A and at least one layer B, wherein said layer A is made of a material selected from the group consisting of pyrolytic graphite, pyrolytic boron nitride, compressed expanded graphite, hot-pressed turbostratic boron nitride, compressed graphene flakes, compressed hexagonal boron nitride flakes, graphitized graphene oxide flakes or a combination thereof; and said layer B is made of a composite comprising a polymeric matrix and 2D flakes, said 2D flakes being made of a material selected from the group consisting of graphene, graphene oxides, reduced graphene oxide, heteroatom-doped graphene, hexagonal boron nitride, metal chalcogenides, metal oxides, metal chalcogenide halides, metal halides, phosphotrichalcogenides, MXenes, metal carbides, metal nitrides, layered hydroxides, alkaline-earth metal silicides, alkaline-earth metal bromides, alkaline-earth metal germanides and alkaline-earth metal stannides, layered peroskivtes, phosphorene, silicene, antimonene, germanene, boronene, stanene, bismuthene and combination thereof. It further relates to a coated substrate comprising a substrate and the coating system.

### CROSS-REFERENCE TO RELATED APPLICATIONS

This patent application is related to Italian Patent Application No. 102021000013169 filed on May 20, 2021, the entire disclosure of which is incorporated herein by reference.

### TECHNICAL FIELD OF THE INVENTION

The present invention concerns a coating system for protecting a substrate, in particular a metallic or plastic substrate, with superior and long-lasting anticorrosion, barrier, antierosion and antioxidant properties, with excellent mechanical properties and that allows a reduction of polymer outgassing effects.

### STATE OF THE ART

A paradigm shift in developing advanced anticorrosion and encapsulant systems is demanded to enable substantial progresses for a wide range of applications, from massive marine structures and aerospace constructions to electronics, including telecommunications, networking, electronic components, industrial and consumer electronics.

Current material protecting systems are often inadequate to contrast material degradation in current infrastructures, transportation, production, and manufacturing.

Efficient material protection is a major key to the advancements of future applications, including novel concepts of infrastructures (e.g., port quays, offshore structures, transmission pipelines, highway bridges, water transmission and distribution systems) and electronics (e.g., the so-called “More than Moore” electronics), or even space missions.

For example, chlorine-induced corrosion is a well-known issue in marine applications and other terrestrial applications, e.g., underground mines and coal preparation plants. Besides, it can be a serious problem in extra-terrestrial applications, as already diagnosed on Mars, whose soil contains elevate concentrations of perchlorate compounds.

The ambient oxidation susceptibility of metals and semiconductors in electronics, as well as the overheating caused by high power density per unit of area in miniaturized integrated circuits (i.e., microchips), require effective multifunctional (e.g., antioxidant and heat-dissipating) protective systems, which concomitantly contrast blasting effects, e.g., metal ion migration.

In industrial plants, halides (including fluorides, chlorides, bromides and iodides), acids (e.g., sulphuric acid and hydrochloric acid), and hydrogen are further examples of corrosive agents which can endanger the plant functionalities and structural integrity.

In near-Sun space, materials must withstand elevate temperatures (>400° C.), as well as electromagnetic radiations and solar wind. In low Earth orbit (LEO), atomic oxygen causes severe erosion of materials, such as polymers, which have to be properly modified or protected by durable atomic oxygen-resistant coatings. Out-gassing of polymers under space environments, such vacuum as and wide-temperature range thermal cycles changes their composition, dimensions, and ultimately, degrades their performance. Therefore, the resistance of polymer to concomitant factors, e.g., high-energy space radiation, atomic oxygen and outgassing is still a material science challenge for forefront applications.

In chlorine-rich environments, such as seawater and splash zones, the metals used for structural applications (e.g., iron and its alloys, such as steels) are traditionally protected by metallic, inorganic and organic coatings.

Galvanization processes, e.g., hot-dip galvanization, consist in applying protective zinc coatings to iron and its alloys to prevent rusting by forming zinc carbonate (ZnCO₃) films protecting the metals underneath.

However, the corrosion of galvanized iron and iron alloys is drastically enhanced in chlorine water, in which the solid zinc (or ZnCO₃) is rapidly converted in soluble zinc chloride, which then washes away. These effects are commonly observed in galvanized frames in cold sites due to the presence of road salt, as well as in galvanized structural steel used indoors above chlorine pools.

Acidic environments can further accelerate the corrosion of galvanized iron and iron alloys, as shown in corrugated iron sheet roofing.

Inorganic salt (e.g., phosphate, chromate, molybdate, nitrate, borate, and silicate) coatings are often used as corrosion-inhibiting primers. However, such inhibiting pigments typically fail in providing uniform material protection, and their aqueous solubility often causes their release, which is a cause of blistering effects in presence of overcoatings. Inhibitive pigments can also be used in barrier coatings, i.e., dense and cohesive polymeric and inorganic coatings that are impermeable towards corrosive species. However, effective protective coatings intrinsically contrast the release of the inhibitors, thus hindering their effective utilization.

Barrier coatings can be both organic, e.g., epoxy coatings, or inorganic coatings, e.g., silica films based on tetraethyl orthosilicate and other alkali metal silicates. For large-area applications, organic coatings are produced by depositing either solvent- or water-borne resins, while inorganic coatings are obtained through sol-gel processes. However, the resulting organic coatings generally show insufficient impact resistance, creation of crack or micro-pores during the deposition, as well as the permeability of the corrosive agents, resulting in insufficient long-term protection. Meanwhile, inorganic coatings are inherently brittle requiring blending with organic coating materials.

Although the recent progresses achieved in hybrid inorganic/organic coatings, their anticorrosion performances have not accomplished yet the protection requirements for marine structures, which are preferably designed using cathodic protection systems.

Lastly, sacrificial coatings are also used in form of primers to protect the underlying metals. Such coatings are made of metals that easily oxidize (e.g., zinc and aluminum) to protect the underlying metal from further corrosion. Therefore, their working mechanism resembles the cathodic protection realized by using sacrificial anodes. However, the effectiveness of a sacrificial coating lasts until it remains, and subsequent permeation of water (especially in submerged structures) may lead to the corrosion the sacrificial agents. Moreover, since the performance of sacrificial coating depends on the transfer of the galvanic current, the sacrificial coating must exhibit low content of binders (even <10 wt % for Zn-based coatings) to ensure the electrical contact between the sacrificial metallic nanoparticles and the substrate. Consequently, the adhesion and cohesion properties, and the resistance to impacts, are insufficient for applications subjected to mechanical stresses.

Aluminum is a lightweight material used in form of foils as physical barrier against oxygen and moisture, especially in laminated encapsulants. However, aluminum and its alloys undergo pronounced crevice corrosion in presence of chlorides, sulphate salts, alkaline and acidic salts.

Although aluminum oxides, as well as silicon dioxide and chromium oxides, are used as alternatives to expensive gold and platinum to protect spacecraft parts from atomic oxygen-induced corrosion (or erosion), the realization of the corresponding coatings requires separate processing steps that are difficult to implement uniformly on complex shapes, while jeopardizing the integrity of the coating themselves from manufacturing, handling storage and impact of space-particles (e.g., micrometeorite). When such metal oxide coatings are used to protect atomic oxygen-sensitive polymers, the mismatch between the coefficient of thermal expansion of the substrate polymer and the coating can cause spalling, cracking, or disbonding upon thermal cycling, leading to the coating failure. Furthermore, such protective coatings are brittle, and can therefore be easily damaged by mechanical stresses, e.g., bending and folding, resulting inadequate to protect flexible systems.

In space applications, silicone-based coatings are regularly used to protect atomic oxygen-sensitive plastics, due to their excellent t resistance to atomic oxygen and electro-magnetic radiations. Unfortunately, outgassing of volatile silicones leads to the formation of contaminants, which form deposit of carbon-containing silicon dioxide in presence of atomic oxygen bombardments. The non-transparency of these deposits have deleterious consequence in optical systems and solar panels, as observed in the Mir space station.

Therefore, cutting-edge technologies for long-term material protection in both ambient and harsh environments are demanded to guarantee technology progresses in a plethora of current and future applications, to provide environmental, public and private safety, and to save billions of dollars worldwide by overcoming current limitations of the existing material protecting systems.

### Subject and Summary of the Invention

The object of the present invention is therefore to provide a coating system with superior and long-lasting anticorrosion, barrier, antierosion and antioxidant properties, with excellent mechanical properties and that allows a reduction of polymer outgassing effects.

Said object is achieved by means of a coating system according to claim 1 and a coated substrate according to claim 7.

The coating system according to the invention shows superior anticorrosion properties compared to traditional anticorrosion coatings. For example, structural steels (typical grades are S275 and S355, while other are S195, S235, S420, and S460) coated with a μm-thick coating system of the invention have corrosion rates (CRs) in 3 wt % NaCl aqueous solution of <10⁻⁵ mmpy, which are enormously inferior to the CR of structural steel (on the order of 0.1 mmpy) and orders of magnitudes lower than structural steel coated by prototypical anticorrosion epoxy coatings (on the order of 10⁻² and 10⁻³ mmpy, depending on the amount of Zn).

These long-lasting anticorrosion properties, are not limited, for example, by the progressive consume of Zn in Zn- or other sacrificial anodic materials-enriched anticorrosion cathodic coatings based on cathodic protection mechanisms.

The coating system according to the invention additionally shows superior barrier properties against gases (e.g., radical ones and water vapour), liquids (e.g., water/moisture) and ions (e.g., chlorides) compared to traditional polymeric and metallic encapsulants (e.g., aluminum). For example, the oxygen transmission rate (OTR) (measured at 25° C. at ˜0% relative humidity —RH—) of μm-thick coating systems of the invention is even less than 10⁻³ cc/(m²×day), which is significantly inferior to the OTR of polyethylene/aluminum/polyethylene laminates with a similar thickness (on the order of 0.01 cc/(m²×day), and enormously inferior to the OTRs of prototypical polymeric encapsulants (on the order of 10³ cc/(m²×day) for ethylene vinyl acetate films; on the order of 10² cc/(m²×day) for polyvinyl butyral films). The water vapour transmission rate (WVTR) (measured at 23° C. and 85% RH) of a μm-thick coating system of the invention is even less than 10⁻⁵ g/(m²×day), which is significantly inferior to WVTRS of polyethylene/aluminum/polyethylene laminates with similar thickness (between 10⁻³ and 10⁻⁴ g/(m²×day)) and prototypical encapsulants (between 10² and 10³ g/(m²×day) for ethylene vinyl acetate films; between 10¹ and 10² g/(m²×day) for polyvinyl butyral films). These long-lasting barrier properties are enhanced in comparison to traditional metallic and polymeric coatings, whose oxidized products are volatile without resulting in self-healing effects as those occurring for the coating system of the invention.

Moreover, the coating system according to the invention shows a reduction of polymer outgassing effects in presence of vacuum or during wide-temperature range thermal cycles compared to traditional polymeric coatings, such as silicone-based coatings that are regularly used to protect atomic oxygen-sensitive plastics in space applications.

The coating system according to the invention shows multifunctionalities, including anticorrosion/antierosion/antioxidant properties, high thermal conductivity, high dielectric strength, optimal mechanical properties (e.g., tensile/compression strength, abrasion resistance, wear resistance), which are typically unexpressed by traditional single-function coatings (e.g., anticorrosion coatings, anti-atomic oxygen-induced erosion, high-dielectric strength coatings and thermally conductive coatings). For example, the antioxidant properties of the materials composing layer B, such as h-BN, can reduce the UV illumination-/atomic and radical oxygen-induced oxidation of the polymer composing the layer B by more than 30%.

The coating system according to the invention shows also high versatility of application, since it is applicable to both metallic and polymeric substrates, which can even have a complex shape and be either rigid or flexible. In the coating system can be even applied to addition, traditional protective coatings, complementing other protective functionalities, and further increasing the protective performance of the coatings themselves.

Additionally, the coating system of the invention can operate in a wide range of temperature, e.g., the minimum temperature depends on the desired coating system brittleness and the maximum temperature is higher than 150° C. (in some embodiments even higher than 400° C.), thanks to the high thermal stability of the layers A and the thermal stabilizing properties of the 2D flakes composing the layers B.

The coating system of the invention shows excellent mechanical properties, such as high tensile strength of layer A in the direction parallel to layer A itself (e.g., higher than 100 MPa for pyrolytic graphite); mechanical protection against compressive stress provided by the elasticity and deformability of layer B. Noteworthy, the 2D flakes in layer B can improve the mechanical properties (e.g., tensile/compression strength, abrasion resistance, wear resistance) of the polymers of layer B thanks to their high Young module (e.g., >0.8 TPa for single-layer h-BN flakes), high fracture strength (e.g., >70 GPa for single-layer h-BN flakes) and lubricant properties.

The coating system of the invention shows high dielectric strength, due to the high dielectric strength of the 2D flakes of layers B, e.g., higher than 1 MV/cm for the case of single-/few-/multi-layer h-BN flakes.

The coating system of the invention shows also high thermal conductivity, due to thermally conductive materials of layer A (e.g., graphitic and boron-nitride base materials), as well as the 2D flakes of layer B (e.g.: single-layer h-BN flakes with a thermal conductivity higher than 700 W/(mK); few-/multi-layer h-BN flakes with a thermal conductivity higher than 100 W/(mK).

The coating system of the invention shows also high safety and reliability, thanks to the flame-retardant properties of the 2D flakes of layers B, as well as the oxygen barrier expressed by layer A (OTR measured at 25° C. at ˜0% relative humidity of μm-thick layer A less 10⁻³ cc/(m²×day)).

Lastly, the coating system of the invention can be assembled and applied easily using lamination processes (pressure-assisted), thermo-deposition processes, bonding processes based on electric or magnetic induction heating, liquid-phase deposition processes for layers B (e.g., doctor blading, screen printing, flexographic printing, gravure printing, and spray coating), including their roll-to-roll or sheet-to-sheet forms.

According to a first aspect of the present invention the coating system for protecting a substrate comprises at least one layer A and at least one layer B.

The mechanical, thermal, chemical, electrical and ion/gas barrier properties of layer A and layer B synergistically determine the properties of the whole coating system.

### Layer A

Layer A is made of a material selected from the group consisting of pyrolytic graphite, pyrolytic boron nitride, compressed expanded graphite, hot-pressed turbostratic boron nitride, compressed graphene flakes, compressed hexagonal boron nitride flakes, graphitized graphene oxide flakes or a combination thereof.

The pyrolytic graphite used for layer A can be a form of synthetic graphite characterized by a low mosaic spread angle (typically ≤10°), which means that the individual graphite crystallites are almost aligned with each other. Some covalent bonds occur between the graphene sheets composing the graphite crystallites. Pyrolytic graphite is obtained by the graphitization heat treatment of pyrolytic carbon, as well as by gas-phase pyrolysis (i.e., thermal cracking of hydrocarbons) followed by carbon deposition (i.e., chemical vapor deposition) at a temperature above 2500° C.

Practical preparation of large-area pyrolytic graphite films through “solid-phase method” consists in high-temperature heat treatment of specialized polymer films, e.g., the pyrolysis of commercially available polyimide film named “Kapton” followed by graphitization. The final mosaic spread depends on the carbon precursor, temperature and mechanical (compression and tensile) stresses applied during the graphitization process. The final mosaic spread determines the quality of the pyrolytic graphite, categorized in (thermally) annealed pyrolytic graphite (APG) (typical mosaic spread ranging from 5° to 10°) or highly oriented pyrolytic graphite (HOPG) (typical mosaic spread<2°). Stress recrystallization methods, and substrates of graphene or high-quality pyrolytic graphite (e.g., HOPG) or hexagonal pyrolytic boron nitride, can be used to improve the graphitization processes to give highly oriented graphite.

Pyrolytic boron nitride, also named chemical vapor-deposited boron nitride or white graphite, is a dense laminar anisotropic form of h-BN, in which the hexagonal crystallites are aligned with their c-axes preferentially perpendicular to the substrate. It can be produced by following the procedures described in U.S. Pat. No. 3,152,006.

Briefly, process vapors of ammonia and a gaseous boron halide (e.g., boron trichloride) are decomposed and inter-reacted within the temperature range between 1450 and 2300° C. and at a pressure below 50 Torr. Pure boron nitride sublimes in one atmosphere of nitrogen at temperatures ranging from 2330° C. to 3000° C., compared with 3700° C. for graphite.

Similarly to pyrolytic graphite, compression annealing causes the recrystallization of the pyrolytic boron nitride in a highly oriented structure, which is the insulating analogue of the HOPG. Self-standing highly oriented pyrolytic boron nitride is produced by depositing the pyrolytic boron nitride onto substrates that are subsequently removed by means of thermal oxidation in form of gas (as for the case of graphite, as described in U.S. Pat. No. 4,402,925A), or chemical etching (as for the case of metal-based substrates).

Compressed expanded graphite is formed using select acid-treated graphite, which is then compressed after undergoing high-temperature expansion.

Hot-pressed turbostratic boron nitride (sometimes referred as thermally transformed oxidized hexagonal-boron nitride (h-BN) flakes) is a nearly full-density material produced by hot pressing submicron, turbostratic boron nitride in the presence of a binder phase under a temperature approaching 2000° C. and a pressure above 10 MPa.

Once the binder phase is leached from the product, high purity grades of hot-pressed boron nitride can be obtained. However, it is technologically challenging to obtain thin (<100 μm) films with high flexural strength comparable to (pyrolytic) graphite foils.

Compressed graphene flakes and compressed h-BN flakes can be produced by compressing three-dimensional (3D) graphene and 3D h-BN, respectively, produced through chemical vapour deposition on a metal (e.g., nickel) template, which is then removed through chemical etching.

Alternatively, films of exfoliated graphene or h-BN flakes deposited on layer B can be pressed (preferably at more than 100 Bar) to obtain compact structures resembling the pyrolytic ones (flakes preferentially oriented with their planes parallel to the substrate). The graphene and the h-BN flakes are produced by liquid-phase exfoliation methods, such as wet-jet milling exfoliation described in patent No. WO2017089987A1. A polymeric binder with a content <10% can be added to exfoliated flakes to improve the adhesion between themselves. In this case, a subsequent thermal treatment is used to remove the polymeric binder or carbonize it. The temperature of the thermal treatment depended on the decomposition or carbonization temperature of the polymeric binder, as well as by the environmental conditions (e.g., air or inert atmosphere). The deposition of the graphene and h-BN flakes are performed using printing techniques, e.g., spray coating, doctor blading, screen printing, flexographic printing, and gravure printing. Alternatively, self-standing graphene and h-BN papers, as those obtained through vacuum filtration of the dispersions of corresponding flakes, can be pressed once transferred onto layer B.

Graphitized graphene oxide flakes are used to produce graphite-like densely packed graphitic foils (also called graphenic foils) prepared by thermally transforming films of graphene oxide flakes.

More in detail, graphene oxide foils are produced by pressure-assisted thermal decomposition of graphene oxide films followed by hot-pressing at high temperature (hundreds or thousands of ° C., e.g., 2000° C.). The pressed films are subsequently heated at a temperature higher than 2000° C. (e.g., 2750° C.) to lead to their graphitization.

Preferably, a sheet of pyrolytic graphite is used.

Layer A determines the high impermeability to gases (e.g., radical ones and water vapour), liquids (e.g., water/moisture) and ions (e.g., chlorides). Layer A withstands high temperatures (>150° C.) while preserving its protective properties against corrosive/erosive/oxidizing agents. Layer A provides a mechanical reinforcement of coating system in the direction parallel to the layer itself.

In some of the embodiments, the material of layer A reacts with corrosive/erosive/oxidizing agents to form non-volatile species that provide a structural repairing (self-healing effect) of the layers themselves, which maintains or even improve their protective properties.

### Layer B

Layer B is made of a composite comprising a polymeric matrix and 2D flakes.

The polymeric matrix is made of a polymer selected from the group consisting of epoxies, acrylic polymers, polymeric organosilicon polymers, polyurethanes, polyisobutylenes, vinyl polymers, polyvinyls, ionomers, polyaryletherketones, polyphenylsulphones, polyamides, polyimides, acrylonitrile butadiene styrene, polyesthers, polycarbonates, polyketones, polyoxymethylene, polyphenylene sulphide, polyethers (e.g., polyphenylene oxide), polysulphones, poly (p-phenylene), fluoropolymers, (e.g., poly-tetrafluoroethylene, polyvinylidene fluoride, fluoroethylene vinyl ether -FEVE-), poly (methylmethacrylate), poly (ethylene-vinyl acetate) and acrylonitrile-butadiene-styrene. Preferably, polyvinyl butyral, polyisobutylene, polyether ether ketone, polytetrafluoroethylene, polyphenylsulphones and ethyl vinyl acetate are used.

In some embodiments, polyvinyl butyral and polyisobutylene are used because of their excellent barrier properties against oxygen and water, as well as ions (e.g., chlorides) and other gases.

In some embodiments, polyphenylsulphones, polyether ether ketone and polytetrafluoroethylene are used because of their excellent mechanical and chemical resistance properties that are retained at high temperatures (>200° C.). Polyphenylsulphones and polytetrafluoroethylene show high dielectric strengths (>500 kV/cm), allowing layer B to withstand high electric field.

The 2D flakes are made of a material selected from the consisting of graphene, graphene oxides, reduced group graphene oxide, heteroatom-doped graphene, (including boron-, nitrogen-, phosphorus-, sulphur-, fluorine-doped graphene, mono-binary, ternary-doped graphene), hexagonal boron nitride (h-BN), metal chalcogenides (e.g., metal dichalcogenides, metal monochalcogenides, metal trichalcogenides), metal oxides, metal chalcogenide halides, metal halides, phosphotrichalcogenides, MXenes, metal carbides, metal nitrides, layered hydroxides, alkaline-earth metal silicides, alkaline-earth metal bromides, alkaline-earth metal germanides and alkaline-earth metal stannides, layered perosvkites, elemental 2D materials beyond graphene such as phosphorene, silicene, antimonene, germanene, boronene, stanene and bismuthene) and combination thereof. Preferably h-BN flakes or graphene flakes are used.

The 2D flakes can be flakes of layered materials or flakes of non-layered materials produced from the transformation of flakes of layered materials (e.g., topochemical transformation methods), synthetic methods (i.e., wet chemical syntheses such as surface-energy-controlled synthesis (oriented-attachment growth), template-directed synthesis, confined space synthesis, colloidal synthesis and other solvothermal methods, liquid-phase exfoliation, such lamellar as intermediate-assisted exfoliation) or dry chemical methods (e.g., chemical vapour deposition, van del Waals epitaxy).

2D flakes include single-layer flakes, as well as few (i.e., ≤5)-layer flakes and multi (i.e., >5 and <30)-layer flakes. Said flakes have an aspect ratio (i.e., surface-to-thickness ratio) equal or higher than 10. Once integrated into the polymeric matrix, they act as physical and/or chemical barriers against gases (including radicals), ions and liquids (including moisture).

2D flakes regulate the crystallization of the polymeric matrix used to formulate layer B. For example, typically when present in an amount equal to or lower than 5% wt of the total weight if layer B, graphene and h-BN flakes can enhance the density (i.e., the compactness) of layer B, thus reducing the permeability of layer B to gases, ions and liquids. Moreover, the 2D flakes represent a barrier to the propagation of crack within polymeric matrixes. Said effects improve the anticorrosion/antierosion/antioxidation properties of layer B, reducing the corrosion/erosion/oxidation of either layer A or the substrate to protect.

In some embodiments, 2D flakes, such as h-BN, oxidize to reduce the oxidation-induced damage of the polymer matrix (e.g., polymer oxidation, polymer photo-oxidation, atomic oxygen-induced polymer erosion) by acting as atomic oxygen scavengers.

In some embodiments, 2D flakes absorb UV light, protecting the polymeric matrix by UV light, thus acting as UV stabilizers.

In some embodiments, 2D flakes improve the mechanical properties (e.g., tensile/compression strength, Young's module, wear resistance, abrasion resistance) of the polymer. In particular, 2D flakes that oxide in non-volatile species are used to provide a structural repairing of the polymeric matrix by filling the voids produced by corrosion effects and densifying/compacting the layer B as the polymer is corroded (self-healing effect).

In some embodiments, 2D flakes increase the dielectric strength of the polymeric matrix of layer B thanks to their high dielectric strength (e.g., >1 MV/cm for the case of single-/few-/multi-layer h-BN flakes).

In some embodiments, 2D flakes increase the thermal conductivity of the polymeric matrix of layer B thanks to their high thermal conductivity (e.g., >700 W/(mK) for single-layer h-BN flakes, >100 W/(mK) for few-/multi-layer h-BN flakes).

In some embodiments, 2D flakes improve the mechanical properties (e.g., tensile/compression strength, abrasion resistance, wear resistance) of polymeric matrix of layer B thanks to their high Young module (e.g., >0.8 TPa for single-layer h-BN flakes), high fracture strength (e.g., >70 GPa for single-layer h-BN flakes) and lubricant properties.

In some embodiments, 2D flakes act as flame-retardants. For example, some 2D flakes are stable at high temperature (e.g., h-BN flakes are stable up to 1100° C. in air, well above the thermal stability of the polymeric matrix) and their 2D shape provides a flake-based template for char, promoting the formation of multiple and overlapped dense char layers. The latter act as physical barriers to delay the outgassing of pyrolysis products, while reducing the heat transfer from the heat source, the diffusion of oxygen and the polymer dripping.

Besides, thanks to their large specific surface area (e.g., >2630 m²/g for single-layer graphene, ˜1900 m²/g for pyrolyzed h-BN monolayers), they efficiently adsorbs flammable organic volatiles (e.g., iodine vapor for the case of h-BN flakes), whose release and diffusion are also impeded during combustion processes. In some embodiments, the high in-plane thermal conductivity of 2D flakes (e.g., >700 W/(mK) for single-layer h-BN flakes, >100 W/(mK) for few-/multi-layer h-BN flakes, >3000 W/(mK) for single-layer graphene) improves the thermal conductivity of the polymeric matrix used in layer B, while acting as thermal stabilizer.

In some embodiments, electrically conductive 2D flakes that are more reactive (that is anodic) than the conductive materials used in layer A (e.g., graphitic materials) or in the substrate to protect, are used in layer B to provide cathodic protection of layer A or the substrate to protect, respectively.

In some embodiments, 2D flakes are h-BN flakes, since they have an optimal impermeability to corrosive/erosive/oxidizing agents. In addition, h-BN flakes have a high temperature oxidation resistance (up to 1100° C. in air, well above the thermal stability of polymeric matrix). In addition, h-BN flakes oxidize to boron oxides (e.g., boron trioxides —B₂O₃—). The latter provide the self-healing by forming effect a barrier against corrosive/erosive/oxidizing agents, while acting as UV absorbers and resistant material against atomic oxygen-induced corrosion/erosion effects.

In some embodiments, the 2D flakes of layer B react with corrosive/erosive/oxidizing agents to form non-volatile species that provide a structural repairing (self-healing effect) of the layer themselves, filling the void generated by corrosion/erosion effects, thus maintaining or even improving the initial protective properties of coating system. Layer B provides optimal adhesion to substrates, which can be the layer A or the substrate to protect.

Layer B determines the mechanical properties of the coating system, protecting layer A from mechanical stresses, in particular compressive stresses perpendicular to the layers themselves. The elasticity of layer B allows the coating system to exhibit a tensile strength determined by layer A. Layer B introduces a further protective barrier against the corrosive/erosive/oxidizing agents, including gases (e.g., radical ones and water vapor), liquids (e.g., water/moisture) and ions (e.g., chlorides).

In some embodiments, layer B withstands to high temperature (>150° C.), leading to a coating system capable to operate at high temperatures (>150° C., in some embodiments >400° C., depending on the decomposition temperature of the polymers used in layer B, e.g., >280° C. for polyether ether ketone -PEEK-, >350° C. for polytetrafluoroethylene, and polycarbonate, >400° C. for polydimethylsiloxane; noteworthy, the decomposition temperature and the performance of PS can vary depending on the environmental circumstances).

According to an embodiment of the invention, the ratio between the mass of the 2D flakes and the mass of the polymeric matrix in layer B is between 0.01:99.99 and 50:50. Preferably, this ratio is between 1:99 and 30:70, more preferably between 1.5:98.5 and 10:90, even more preferably between 5:95 and 20:80.

According to an embodiment of the invention, layer B can additionally comprise at least one additive selected from the group consisting of plasticizers, anti-plasticizers and stabilizers.

Plasticizers are oily but non-volatile compounds that improve the softness and the flexibility of the polymeric matrix, while increasing the plasticity, decreasing the viscosity, or decreasing the friction during handling in manufacture. Suitable plasticizers can be dicarboxylic/tricarboxylic esters, adipates, sebacates, maleates, trimellitates, azelates, benzoates, sulphonamides, organophosphates, glycols, polyethers and phthalate esters.

Anti-plasticizers have opposite functionalities. Suitable anti-plasticizers can be tricresyl phosphate, butylphthalide and pentachlorobiphenyl.

Stabilizers can be antioxidants (e.g., primary, and secondary antioxidants), anti-ozonants, light stabilizers (e.g., UV absorbers, quenchers of excited states and hindered amine light stabilizers), acid scavengers, metal deactivators, heat stabilizers, flame-retardants, and biocides. An example of stabilizer is benzotriazole.

### Production of the Coating System of the Invention

To produce the layer B, either melt blending or wet methods, as well as the combination thereof, can be used, as described hereafter.

Melt blending methods can be selected among extrusion (including film extrusion), injection moulding, casting, and other forming and hot pressing, thermoforming processes. They allow the production of layer B in the form of foils or sheets, while controlling the thickness of layer B, by starting from the substance powders/pellets, thus obtaining a self-standing layer B. The parts of the machinery (e.g., length to the diameter of the screw, type of screw, extruder die, film puller) as well as parameters used for the melt blending processes are selected accordingly. The thickness of layer B determines the flexibility or the rigidity of layer B, depending on their flexural modulus of its components.

Layer B can be produced with non-planar shape, preferably curved shapes, which can be then coupled with unfolded layer A.

Extrusion coating can be used to coat the layer B directly on layer A or on the substrate to be protected.

A controlled atmospheric environment (e.g., high-vacuum, inert nitrogen or argon atmospheres) is optionally used to avoid the thermal/chemical degradation of the components of layer B and/or to avoid the formation of structural defects in the final shape and thickness of layer B.

In some embodiments, self-standing layer B is laminated onto layer A or onto the substrate to be protected using lamination processes.

Alternatively, self-standing layer B is deposited onto layer A or onto the substrate to be protected by thermo-deposition processes, in which layer B is heated above its melting temperature followed by a cooling down at temperature below its melting temperature (preferably below glass temperature), determining its attachment to the underlying layer during its solidification. Pressure can be applied during the deposition of layer B.

Alternatively to lamination and thermo-deposition processes, layer B can be applied to conductive substrates (including some forms of layer A and some forms of the substrate to be protected) through bonding processes based on electric or magnetic induction heating. Electric heating applies AC or DC or pulsed voltages between separated parts of the conductive substrate to force an electrical current. The passage of the electrical current through the electrically conducting substrate (i.e., the conductor) causes the ohmic heating (or resistive heating) between the conductor parts. Said heating is commonly known as Joule heating because of its relationship to Ohm's law. The heating power (P) is expressed by the following equation: P=I×R², in which I is the current flows through the conductor and R is the conductor resistance. Induction heating is the process of heating an electrically conducting substrate (i.e., the conductor) by electromagnetic induction. An induction heater is based on an electromagnet and an electronic oscillator. The latter passes a high-frequency AC current through the electromagnet, inducing and alternating magnetic field. The alternating magnetic field penetrates the conductor, generating eddy currents inside the conductor. The eddy currents flow through the resistance of the conductor, which is heated by Joule heating. In ferromagnetic (and antiferromagnetic and ferrimagnetic) conductors (e.g., iron, which is an example of material to protect), heat may also be generated by magnetic hysteresis losses. As described in the prior art, the frequency of current used for induction heating depends on the object size, material type, coupling between the work coil and the object to be heated, and the penetration depth.

In some embodiments, the application of self-standing layer B to the substrate can be implemented in roll-to-roll and sheet-to-sheet manufacturing chains.

In some embodiments, the extruded materials are grinded in form of powder and applied on the substrate by spray coating by means of electrostatic sprayers (the electrostatic charge can be imparted to the powder with voltage, called corona charging, or by frictional contact with the inside of the gun barrel, called tribo charging). After spraying, high-vacuum sintering process can be applied. Reducing agents can be used to chemically create the polymer coating. Before spraying, the surface to be coated can be treated by sandblasting to promote the polymer adhesion through mechanical interlocking.

Wet methods are liquid-phase compounding processes followed by liquid-phase deposition processes. In said processed, the polymeric matrix and 2D flakes are added to a solvent or a mixture of solvents. Suitable solvents are those capable to dissolve/disperse the polymeric matrix, preferably exhibiting similar surface energy to those of 2D flakes. The solvent can be protic or aprotic, polar or apolar, depending on the other substances present in the mixture. The solvent can be one or a combination of the following solvents: ketones (e.g., acetone, methyl ethyl ketone, hexanone, cyclohexanone), aromatic solvents (e.g., toluene, xylene, benzonitrile, chlorobenzene), glycol ethers (e.g., polyethylene glycol, polypropylene glycol, propylene glycol butyl ether, diethylene glycol butyl ether, propylene glycol polyether, etc.), esters (e.g., ethyl acetate, butyl acetate, ethylene glycol butyl ether acetate and diethylene glycol butyl ether acetate), mineral spirits, alcohols (methanol, ethanol, terpineol, 1-propanol, 2-propanol, 1-butanol, ethylene glycol, propylene glycol), hydrocarbons (e.g., n-hexane, naphtha), terpenes, oils, acetonitrile, N-Methyl-2-Pyrrolidone, N, N-Dimethylformamide, chloroform, 1,3-dioxolane, tetrahydrofuran, carboxylic acids (e.g., acetic acid) and water.

In some embodiments, the polymeric matrix is added and dissolved or suspended (polymer pre-melting can be also applied) in the solvent before adding 2D flakes. In some embodiments, the polymers are in liquid-phase (e.g., epoxy resins and polyols) and solvent addition may be not needed. The resulting mixture is homogenized using agitators and/or mixers/and or homogenizers, possibly heating the mixture below the temperature decomposition of its substances to facilitate the substance dissolutions. A controlled atmospheric environment (e.g., inert nitrogen or argon atmosphere) can be used to avoid the thermal/chemical degradation of the substances composing the mixture. The amount of the solvent is defined by the desired viscosity of the resulting mixture, which can be therefore deposited on layer A or on the substrate to be protected through liquid-phase deposition methods. Said deposition methods can be painting and printing methods, e.g., doctor blading, screen printing, flexo-graphic printing, gravure printing, spray coating, casting, and dip coating. Once the solvent is evaporated, layer B is obtained.

Mixed wet-melt blending methods are processes that are based on both melt blending and wet processes. In this case, the solvent in the mixture produced during liquid-phase compounding of layer B is removed through evaporation and/or filtration processes to obtain a bulky homogeneous composite made of the components of layer B. Subsequently, the resulting bulky composite is transformed in form of powder/pellets through powder/pellet manufacturing processes. The resulting powder/pellets are used to produce layer B through melt blending method processes.

### Structure of the Coating System of the Invention

The coating system of the invention may comprise more than one layer A and one layer B to form a multilayered structure, wherein Layers A and layers B are alternated.

It can be used to produce a coated substrate. The substrate can be made from both inorganic materials (including metal, semiconductors, and insulators), and organic materials (e.g., polymers, including thermosetting and thermoplastic polymers) operating in chemically corrosive/erosive/oxidizing environments. Preferably, it is a metal substrate, more preferably an iron substrate or a structural steel substrate, or a polymeric substrate.

When applied to the substrate, a layer B of the coating system faces the substrate.

Moreover, in the coated substrate, the outer layer is preferably a layer B, which determine the mechanical properties of coating system.

Further characteristics of the present invention will become clear from the following description of some purely illustrative and non-limiting examples.

### BRIEF DESCRIPTION OF THE DRAWINGS

The present invention will be described in detail with reference to the figures in the annexed drawings, which show purely illustrative and non-exhaustive examples in which:

FIG. 1 illustrates polarization sweep voltammetry curves of bare steel, layer B-coated steel, epoxy-coated steel, bi- and tri-layered coating system coated steel. The layers A of the coating system are pyrolytic graphite sheet (thickness=30 μm). The layers B of the coating system are composite of h-BN flakes (5 wt %) and polyvinyl butyral (95 wt %).

FIG. 2 illustrates polarization sweep voltammetry curves of bare steel, layer B-coated steel, epoxy-coated steel, bi- and tri-layered coating system coated steel. The layers A of the coating system are pyrolytic graphite sheet (thickness=30 μm). The layers B of the coating system are composite of h-BN flakes (5 wt %) and polyisobutylene (95 wt %).

FIG. 3 illustrates a) Reflectance spectra of a film made of pristine polyisobutylene and a film made of a composite of h-BN flakes (5 wt %) and polyisobutylene (95 wt %), before and after O₂ plasma treatment. b) Absorption spectra of a film made of pristine polyisobutylene and a film made of a composite of h-BN flakes (5 wt %) and polyisobutylene (95 wt %), before and after Oz plasma treatment.

FIG. 4 illustrates optical photographs of the back side of a tri-layered coating system and a pyrolytic graphite sheet after impact test. The tri-layered coating system was made of a layer A of pyrolytic graphite and a layer B made of h-BN flakes (5 wt %) and polyisobutylene (95 wt %), as described in Example 4.

### DETAILED DESCRIPTION OF PREFERRED EMBODIMENTS OF THE INVENTION

### Example 1

### Production of the Coating System According to the Invention Having Two or Three Layers

Layer A is a 25 μm-thick pyrolytic graphite sheet (PGS, Panasonic).

Alternatively, layer A is formed by high-pressure (100 bar) compression of powder of hexagonal boron nitride (h-BN) flakes or graphene flakes, produced through wet-jet milling exfoliation method. This method is described in WO2017089987A1 (A. Del Rio Castillo et al., Exfoliation of layered materials by wet-jet milling techniques).

Layer B is made of a composite of h-BN flakes (5 wt % of the total weight of layer B) and polymer (95 wt % of the total weight of layer B), in which h-BN flakes were produced through wet-jet milling exfoliation of bulk h-BN crystals, while the polymeric component i is polyvinyl butyral, or polyisobutylene, or polyphenylsulphone. Other h-BN: polymer weight ratio have been also used, i.e., 1:99, 10:9 and 20:80. Graphene flakes, produced through wet-jet milling method, were also used as 2D flakes alternative to h-BN flakes for polyphenylsulphone-based layer B, using a 5 wt % of graphene flakes.

To produce layer B, polyvinyl butyral (powder, analogue of Butvar® B-98) and polyphenylsulphone (beads) were purchased powder from Sigma Aldrich. Polyisobutylene (Oppanol N80, 800,000 MW) was supplied by BASF. All the polymers were used as-received without any further purification. The h-BN flakes comprise flakes of a lateral size between 50 and 500 nm, and thickness between 0.3 and 10 nm.

The h-BN flakes and polymers were added to the solvent (3 mL of solvent for 1 g of solid content), which was one the following: N, N-Dimethylformamide (ACS reagent, 299.0%, Sigma Aldrich) or N-methyl-2-pyrrolidone (ACS reagent, ≥99.0%, Sigma Aldrich) for polyvinyl butyral; tetrahydrofuran (≥99.9%, Sigma Aldrich), chlorobenzene (ACS reagent, ≥99.5%, Sigma Aldrich), carbon tetrachloride (reagent grade, 99.9%, Sigma Aldrich), carbon disulphide (ACS, 99.9+%, Alfa Aesar), methylene chloride (99.6%, Sigma-Aldrich), cyclohexane (ACS reagent, ≥99%, Sigma Aldrich), benzine (ACS reagent, Sigma Aldrich), benzene (99.0%, ACS reagent, Sigma Aldrich), toluene (ACS reagent, ≥99.5%, Sigma Aldrich) or xylene (reagent grade, Sigma Aldrich) for polyisobutylene; N, N-Dimethylformamide (ACS reagent, ≥99.0%, Sigma Aldrich) N-Methyl-2-Pyrrolidone (ACS reagent, ≥99.0%, Sigma Aldrich), or dimethylacetamide (ReagentPlus®, ≥99%, Sigma Aldrich) for polyphenylsulphone.

The mixture was heated at temperature below the decomposition temperature of the substances and agitated under mechanical stirring. Once the mixture was homogenized, an amount of solvent as needed was added to obtain desired viscosity for the deposition processes.

As an illustrative example, the as-produced mixtures were deposited by doctor blading (micrometer adjustable film casting knife)—EQ-Se-KTQ-80F, MTI Corporation) or atomized spray coating (Xcell, Aurel S.p.a.) onto one or both the sides of a layer A made of 25 μm-thick pyrolytic graphite sheet (PGS, Panasonic) or compressed h-BN or graphene flakes, to obtain ˜30 μm-thick layers B. Noteworthy, for doctor blading deposition, the viscosity of the layer B dispersion was adjusted between 200 and 500 mPa·s, while for spray coating, the layer B dispersion used for doctor blading deposition was diluted 1:3. The height of the blade during doctor blading deposition and the amount of dispersion during spray coating deposition were adjusted to obtain the desired layer B thickness. The thickness was measured using a contact profilometer (XP200, Ambios). The resulting coating system have a bi- or tri-layered structure with an average thickness of 55±15 μm and 85±20 μm, as measured by profilometry.

### Example 2

### Production of the Coating System According to the Invention Having Five Layers.

Coating systems according to the invention with more than three layers were produced from the multi-layered structures described in Example 1.

As illustrative example, a layer A consisting of a 25 μm-thick pyrolytic graphite sheet (PGS, Panasonic) was placed and pressed onto the layer B of a tri-layered structure obtained according to Example 1 (structure B-A-B).

The pyrolytic graphite sheet was heated through electric heating at a temperature above the melting point of layer B. For the electric heating, a pulsed DC current of 100 A along the length of the specimen (10 cm×10 cm) was applied using Ag electrical contacts in conjunction with copper wires. The latter were removed at the end of the heating process. This process established the adhesion between layer B and the pyrolytic graphite sheet. Noteworthy, induction heating may be used as viable alternative to electric heating. During the heating process, the pressure was varied within a dynamic range of 0.2-1 Bar, to avoid the excessive compression of layer B, which otherwise may be compromised and contact between the two layers A could occur. A layer B was subsequently deposited on the external layer A. After deposition of layer B, a coating system with a five-layer structure and a thickness of ˜130 μm was obtained.

### Example 3

### Production of the Coating System According to the Invention Having Two or Three Layers.

Layers B alternative to those described in the Example 1 were produced starting from polyether ether ketone (Victrex) or polytetrafluoroethylene (Sigma Aldrich), that were grinded (ZM 200, Retsch) in form of powder and mixed with 1 wt % h-BN flakes (laboratory container mixer, CM 6-12, Mixaco). The so-obtained mixtures were applied on a layer A consisting of a 25 μm-thick pyrolytic graphite sheet by spray coating by means of electrostatic sprayers (Olenyer). After spraying, sintering process was applied (sintering temperature of 265° C. and 400° C. for polyether ether ketone and polytetrafluoroethylene, respectively). When layer B was deposited onto one or both the side of layer A, bi-layered or tri-layered coating systems were obtained with a thickness of ˜130 μm and ˜160 μm, respectively, as measured by profilometry (XP200, Ambios).

### Example 4

### Production of the Coating System According to the Invention Having Two or Three Layers.

As a further illustrative example of layer B that can be used to form the coating system, polyvinyl butyral or ethyl vinyl acetate (vinyl acetate 40 wt %, Sigma Aldrich) mixed with 1 wt % of h-BN flakes produced through wet-jet milling exfoliation were prepared in form of foils by means of extrusion injection moulding, or casting, or thermoforming processes and subsequently applied to an electrically conductive substrate (layer A or the substrate to protect) by means of electric heating, being the applied current in the metallic substrate dissipated in form of heat through the Joule effect. The electric heating process has been described in Example 2. Noteworthy, induction heating may be used as alternative to electric heating. In addition, thermoforming process can be used to directly adhere the layer B to layer A on one or both its side, thus forming a bi- or tri-layered coating system, respectively.

### Example 5

### Production of the Coating System According to the Invention Having Five Layers.

Multi-layered forms of the coating system of the invention with more than three layers were produced from the coating system described in Example 3. A layer A consisting of a 25 μm-thick pyrolytic graphite sheet (PGS, Panasonic) was placed and pressed onto one of the layer B of a coating system described in Examples 3. The pyrolytic graphite sheet was heated through electric heating at a temperature above the melting point of layer B, as described in Example 2. This process established the adhesion between layer B and the pyrolytic graphite sheet. During the heating process, the pressure was varied within a dynamic range of 0.2-1 bar to avoid the excessive compression of layer B, which otherwise would be compromised causing the contacts between the layers A. A layer B was subsequently deposited on the external layer A following the layer B formulation and deposition processes described in previous Examples. After deposition of layer B, a coating system with a five-layer structure and a thickness of ˜130 μm (Ambios XP200 Profiler) was obtained.

### Example 6

Application of the Coating System onto a Metal Substrate.

The tri-layered coating systems described in Example 1 (using polyvinyl butyral or polyisobutylene) were applied onto structural steel substrate by hot pressing (pressure<0.1 bar) at temperature of 200° C. A polyimide film (thickness=0.075 mm, Kapton) was inserted between the top press plate and the coating system to avoid the attachment of top layer B to the press plate. The polyimide film was then delaminated manually by the sample.

During heating, the pressure was varied to not compress the layer B, which otherwise would have been reduced in thickness causing contact between layer A and the structural steel substrate. After the application of the coating system, the thickness of the coating system was 50+10 μm, as estimated by profilometry measurements on a scratched coating system. The corrosion of coated structural steels in 3 wt % NaCl aqueous solution were evaluated by electrochemical methods, following the ASTM G5-14 standard for both the assembly of the sample preparation and measurement protocols. More in detail, a cylinder of structural steel with a diameter of 1.2 cm was coated with a 25 μm-thick resistive heating element via doctor blading deposition, forming a cylindrical sample used as the working electrode. To realize the work electrode assembly described ASTM G5-14, the cylindrical sample was drilled-and-tapped with a 3-48 UNC thread. The working electrode was screwed onto the support rod. A PTFE compression gasket ensures a leak-free seal. The depth of the working electrode is adjustable, allowing easy orientation of the working electrode and the reference electrode bridge tube. Linear sweep voltammetry and Tafel plot analyses were performed as described in ASTM G5-14, using a potentiostat/galvanostat station (VMP3, Biologic) in a three-electrode configuration mode.

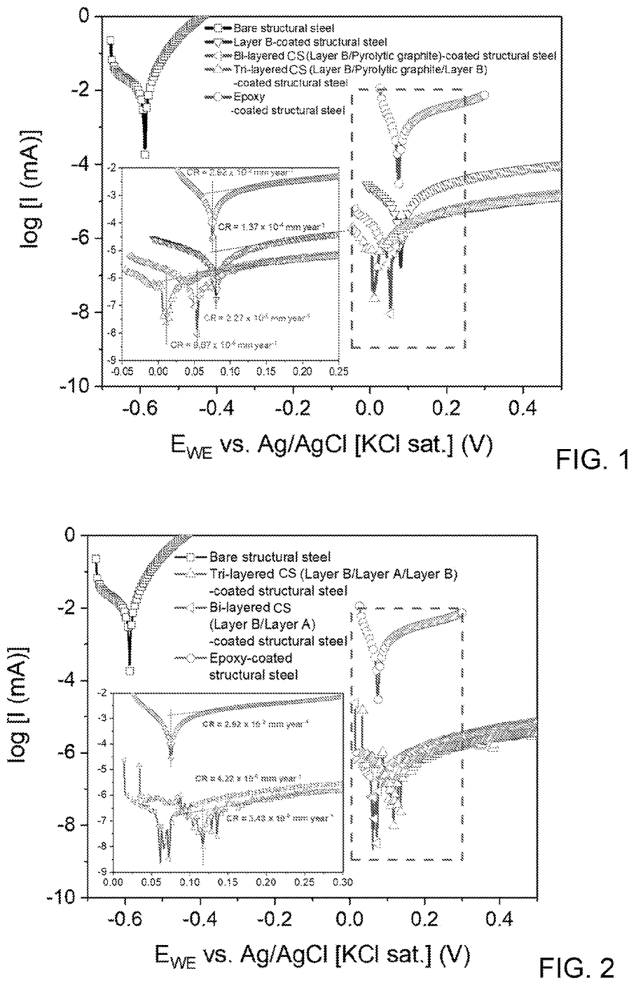

The results are illustrated in FIG. 1 that shows the linear sweep voltammetry curves measured for tri-layered coating system-coated steel (polyvinyl butyral) (Tri-layered CS). The linear sweep voltammetry curves for bare structural steel, layer B-coated structural steel, bi-layered coating system-coated steel (Bi-layered CS) and a steel coated with a commercial anticorrosion epoxy resin (Setra Vernici) are also shown as comparison. As shown in the inset panel, the CRs (measured according to the ASTM G5-14 standard) of the structural steels coated with the tri-layered coating system of the invention are <10⁻⁵ mmpy, which are enormously inferior to the CR of bare steels (on the order of 0.1 mmpy) and orders of magnitudes lower than steel coated by commercial anticorrosion epoxy resin (on the order of 10⁻²). Noteworthy, a reference coating made of a polyvinyl butyral-based single layer B used in PS provides a CR>1·10⁻⁴ mmpy, while only layer A cannot attach to the substrate to protect (therefore, it cannot be used as protective coating). The bi-layered coating system-coated steel also exhibit very low CR (on the order of 10⁻⁵ mmpy), approaching those achieved by the tri-layer PS-coated steel.

FIG. 2 illustrates the results obtained with coating systems of the invention using polyisobutylene as the polymeric matrix of layer B.

As shown in the inset panel, the CRs of the steels coated with the coating systems of the invention are <10⁻⁵ mmpy. More in detail, they are 4.2·10⁻⁶ mmpy and 3.4·10⁻⁶ mmpy for bi- and tri-layered coating system-coated steel, respectively. These CRs are enormously inferior to the CR of structural steels (on the order of 0.1 mmpy) and orders of magnitudes lower than the one of epoxy-coated steel.

### Example 7

The tri-layered coating systems described in Examples 1 and Example 3 have been evaluated as encapsulants, measuring their oxygen transmission rate (OTR) and water vapour transmission rate (WVTR). The OTR has been measured with OX-TRAN® Model 2/22 (Ametek Mocon), while the WVTR has been measured with AQUATRAN® Model 3 (Ametek Mocon). The OTRs of coating systems measured at 25° C. and ˜0% relative humidity are <10⁻³ cc/(m²×day), which are significantly inferior to the OTR of polyethylene/aluminum/polyethylene laminates with similar thickness (on the order of 0.01 cc/(m²×day), and considerably inferior to the OTRs of prototypical polymeric encapsulants (on the order of 10³ cc/(m²×day) for ethylene vinyl acetate films; on the order of 10² cc/(m²×day) for polyvinyl butyral films). Noteworthy, a coating made of one single layer B provides a OTR>1 cc/(m²×day), while only layer A cannot attach to the substrate to protect. The WVTRs of coating systems of the invention measured at 23° C. and 85% RH are <10⁻⁵ g/(m²×day), which are inferior significantly to the WVTRs of polyethylene/aluminum/polyethylene laminates with a similar thickness (between 10⁻³ and 10⁻⁴ g/(m²×day)) and prototypical encapsulants (between 10² and 10³ g/(m²×day) for ethylene vinyl acetate films; between 10¹ and 10² g/(m²×day) for polyvinyl butyral films). Noteworthy, a coating made of the single layer B provides a WVTR>1 g/(m²×day), while only layer A cannot attach to the substrate to protect.

### Example 8

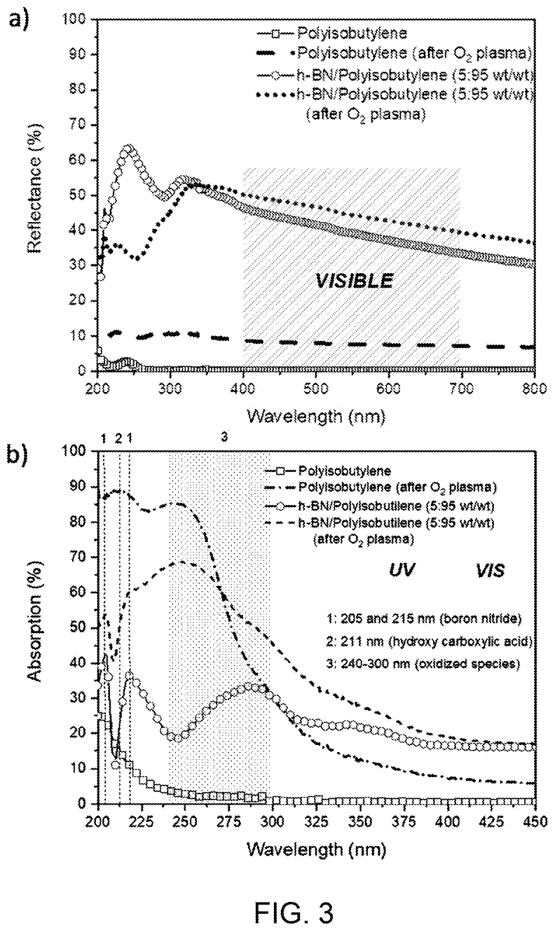

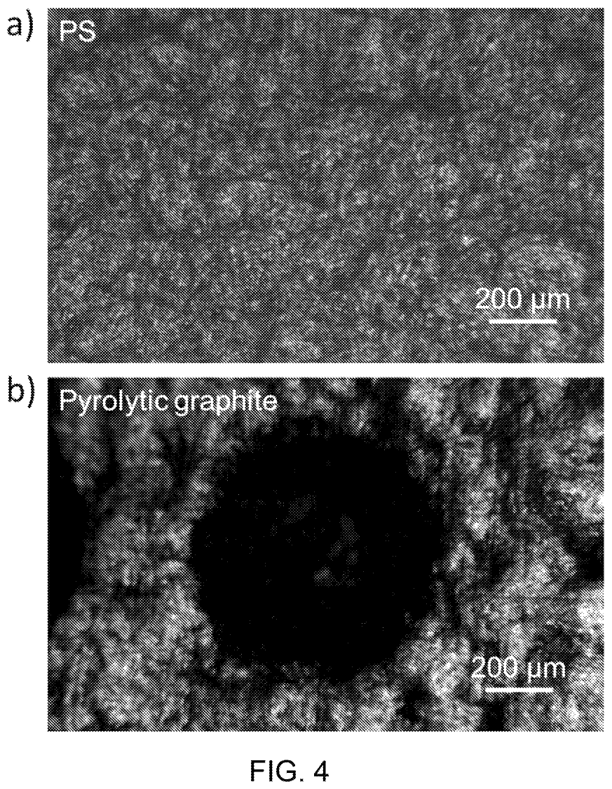

The h-BN flakes in tri-layered coating systems described in Examples 1 have been evaluated as protective agents against atomic and radical oxygen-induced degradation and UV-induced degradation for atomic and radical oxygen- and UV-sensitive polymers, i.e., polyisobutylene. The investigated samples were exposed to 10 min of low-pressure O₂ plasma using a plasma generator operating at 13.56 MHZ (Gambetti, Kenologia Srl) at power of 100 W and pressure of 40 Pa. The UV-vis absorbance and reflectance spectroscopy measurements were performed with Cary Varian 5000 UV-vis spectrometer equipped with integrating sphere. FIG. 3a shows the reflectance spectra of a film made of pristine polyisobutylene and a film made of a composite of h-BN flakes (5 wt %) and polyisobutylene (95 wt %), as described in Example 1 for the fabrication of layer B. The spectra were recorded before and after the 02 plasma treatment. The data indicate that the 02 plasma treatment increases the reflectance of both the samples in the visible spectral region between 400 and 700 nm. The difference between areas calculated by the integral of the reflectance over the wavelength between 400 and 700 nm before and after 02 plasma treatment are 15.8 nm and 22.9 nm for pristine polyisobutylene and polyisobutylene:h-BN (5:95 wt/wt), respectively. This suggests that h-BN flakes reduce the so-called yellowing effect, which is the change of color of plastic. Since the reflectance changes may be also associated to a change of roughness of the material surface, the absorption spectra were also acquired and analyzed to exclude the reflectance contribution to the color change. As shown in FIG. 3b, the O₂ plasma treatment of pristine polyisobutylene causes the formation of carboxylic groups, whose peak is located at 211 nm, and other oxidized species (bands located between 240-300 nm). These products are associated to the chemical degradation and decomposition (e.g., polymer chain braking) of polyisobutylene. The addition of h-BN flakes into polyisobutylene prevents the formation of carboxylic groups, thus protecting the polyisobutylene from degradation under O₂ plasma treatment. As described in the embodiments of the invention, h-BN flakes can oxidize to boron oxides (e.g., boron trioxides —B₂O₃ provide a barrier against corrosive/erosive/oxidizing agents, while acting as UV absorbers and resistant material against atomic oxygen-induced corrosion/erosion effects.

### Example 9

The thermal conductivities of the tri-layered coating systems described in Examples 1 were measured through hot disk method (TPS 3500, Hot Disk Instrument). In fact, thermal conductivity of the coating system depends on the loading of the 2D flakes and the type of matrices used e.g., polyether ether ketone and polyphenylsulphone. In particular, the presence of h-BN and graphene flakes in layer B based on polyether ether ketone or polyphenylsulphone enhances the thermal conductivity by 0.5-22% compared to the pristine polymers, while the presence of pyrolytic graphite of layer A provide in-plane conductivity of 1600 W (m·K)⁻¹.

### Example 10

The in-plane mechanical properties of the tri-layered coating systems described in Example 4 were evaluated using a universal testing equipment (Instron Dual Column Tabletop System 3365). For the illustrative case of coating systems based on a layer B based consisting of h-BN flakes (5 wt %) and polyisobutylene (95 wt %) and pyrolytic graphite as layer A (samples produced by thermoforming the layer B directly on layer A), the measured Young's module is 2542+384 MPa. This value represents a 7% increase of the Young's module of a film of pristine poly vinyl butyral with the same thickness of the coating system (thickness ˜500 μm, as measured with a feeler gauge). Impact tests were also carried out to evaluate the out-of-plane mechanical properties of the coating system, relatively to the layer A. The tests were performed by realizing a hollow punch (diameter size=12 mm, weight=0.3 kg) from a height of 2.5 cm onto tri-layered coating system or pyrolytic graphite foil. As shown in FIG. 4, the pyrolytic graphite is punched, showing a hole over its whole thickness after the test. Contrary, the layer B in the coating system protects the layer A, which preserves its mechanical integrity.

1. A coating system for protecting a substrate comprising at least one layer A and at least one layer B, wherein
said layer A is made of a material selected from the group consisting of pyrolytic graphite, pyrolytic boron nitride, compressed expanded graphite, hot-pressed turbostratic boron nitride, compressed graphene flakes, compressed hexagonal boron nitride flakes, graphitized graphene oxide flakes or a combination thereof; and
said layer B is made of a composite comprising a polymeric matrix and 2D flakes, said 2D flakes being made of a material selected from the group consisting of graphene, graphene oxides, reduced graphene oxide, heteroatom-doped graphene, hexagonal boron nitride, metal chalcogenides, metal oxides, metal chalcogenide halides, metal halides, phosphotrichalcogenides, MXenes, metal carbides, metal nitrides, layered hydroxides, alkaline-earth metal silicides, alkaline-earth metal bromides, alkaline-earth metal germanides and alkaline-earth metal stannides, layered perovskites, phosphorene, silicene, antimonene, germanene, boronene, stanene, bismuthene and combination thereof.

2. The coating system according to claim 1, wherein said polymeric matrix is made of a polymer selected from the group consisting of epoxies, acrylic polymers, polymeric organosilicon polymers, polyurethanes, polyisobutylenes, vinyl polymers, polyvinyls, ionomers, polyaryletherketones, polyphenylsulphones, polyamides, polyimides, acrylonitrile butadiene styrene, polyesthers, polycarbonates, polyketones, polyoxymethylene, polyphenylene sulphide, polyethers, polysulphones, poly(p-phenylene), fluoropolymers, poly(methylmethacrylate), poly(ethylene-vinyl acetate) and acrylonitrile-butadiene-styrene.

3. The coating system according to claim 1, wherein a ratio between the 2D flakes and the polymeric matrix in layer B is in a range between 0.01:99.99 and 50:50.

4. The coating system according to claim 1, wherein a ratio between the 2D flakes and the polymeric matrix in layer B is in a range between 5:95 and 20:80.

5. The coating system according to claim 1, wherein said layer B further comprises at least one additive selected from the group consisting of plasticizers, antiplasticizers and stabilizers.

6. The coating system according to claim 1, wherein it comprises at least two layers B alternating with one layer A.

7. The coating system according to claim 1, wherein the 2D flakes have an aspect ratio equal to or higher than 10.

8. A coated substrate comprising a substrate and a coating system according to claim 1, wherein said layer B faces said substrate.

9. The coated substrate according to claim 8, wherein said substrate is a metal substrate or a polymeric substrate.

10. The coated substrate according to claim 9, wherein said metal substrate is an iron substrate or a structural steel substrate.
